(19) United States
(12) Patent Application Publication
(10) Pub. No.: US 2020/0051036 A1
(43) Pub. Date: Feb. 13, 2020

(54) Assisted Assignments in a Digital Concierge System

(71) Applicant: Medroster.com Corporation, Santa Monica, CA (US)

(72) Inventors: Changgao Yang, Signal Hill, CA (US); Keith Parks, Long Beach, CA (US); Christopher Scott Whitman, Los Angeles, CA (US); Martin Boßlet, Bechhofen (DE)

(21) Appl. No.: 16/538,741

(22) Filed: Aug. 12, 2019

Related U.S. Application Data
(63) Continuation of application No. 62/717,691, filed on Aug. 10, 2018.

(51) Int. Cl. G06Q 10/10; G06N 5/04; G06Q 30/06; H04L 29/08

(52) U.S. Cl. CPC G06Q 10/1097; H04L 67/26; G06Q 30/0631; G06N 5/04

(57) ABSTRACT

A concierge system assists users in completing tasks they have. The concierge system may provide a curated experience, so that the users are provided suggestions in how to complete their tasks. For example, if a user is interested in answering the question on what to have for dinner, the concierge system may provide advice on what to get and help the user have items needed delivered to the user's front door.

### CROSS REFERENCE TO RELATED APPLICATIONS

This patent application claims the benefit of U.S. patent application 62/717,691, filed Aug. 10, 2018, which is incorporated by reference along with all other references cited in this application.

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### BACKGROUND OF THE INVENTION

The present invention relates to a concierge system and, more specifically, provides an intelligent concierge.

The Internet has improved people's lives in many different ways. However, there are some problems that have persisted, even in the digital age. For many people, it is a struggle to get daily tasks done, such as figuring out what to eat for dinner or how to get items conveniently delivered, so that they may free up their time to engage in other activities.

Some services may match people and tasks. However, it is time consuming to use these services, since they require a user to manually identify tasks, persons, and what is needed. The burdensome nature of using these services result in reluctant adoption of these services by users, since the users may find the convenience of using these services outweighed by the burden of getting started and figuring out how to use the services.

Therefore, there is a need for an improved communication methods to match and assist users in accomplishing their tasks.

### BRIEF SUMMARY OF THE INVENTION

A concierge system assists users in completing tasks they have. The concierge system may provide a curated experience, so that the users are provided suggestions in how to complete their tasks. For example, if a user is interested in answering the question on what to have for dinner, the concierge system may provide advice on what to get and help the user have items needed delivered to the user's front door.

In an implementation, the concierge system provides a method including: receiving a task request to be performed at a specified location; retrieving by a first user in a first functional role information on the task request; validating that the first user is associated with an assignment function attribute, where the assignment function attribute designates an associated user as allowing assignments of users to tasks; determining, based on the first user being associated with the assignment function attribute, the task request, and the specified location, second and third users in a second functional role that may be available to complete the task request based at least in part on their relevance to the specified location; transmitting to the first user information identifying that the second and third users may be available to complete the task request; receiving from the first user an indication that the second user but not the third user has been selected to complete the task request; committing in an assigned task database information on the task request and the second user as being selected to complete the task request; and transmitting to the second user that they have been selected to complete the task request and the specified location.

The concierge system may also include: determining, based on a user profile of a customer user making the task request, one or more dishes that may suit the customer; determining a list of cooking ingredients that the customer may use to create the one or more dishes; and indicating, in response to the task request, the list of cooking ingredients to be associated with the task request. The user profile may indicate various preferences or requirements of the customer, such as a dietary preference or an allergy.

The concierge system may include where the first and second functional roles are different functional roles. The first functional role may correspond to a manager. The second functional role may correspond to a staff member. The staff member has additional qualifications that make them suitable to the task request, such as being a driver, chef, shopper, or other qualifications.

The concierge system may include where the task request is retrieved by the first user based on a push command transmitted to the first user's device. For example, the first user receives a push alert on their mobile device that there is a task request. A push alert may also be sent to the second user when they are selected to fulfill the task request.

The concierge system may include where the task request includes the specified location that is manually entered by a customer making the task request. The concierge system may also include where the specified location for the task request is automatically determined, such as a default to a customer user's home address or an address determined using a geolocation technique of the customer user's device.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a distributed computer network.

FIG. 2 shows a computer system that can be used in a concierge system.

FIG. 3 shows a system block diagram of the computer system.

FIGS. 4-5 show examples of mobile devices.

FIG. 6 shows a system block diagram of a mobile device.

FIG. 7 shows a system diagram of the concierge system.

FIG. 8 shows a flow of assigning tasks in the concierge system.

FIG. 9 shows a flow of fulfilling a task request in the concierge system.

FIG. 10 shows a screen for a user to sign up for the concierge system.

FIG. 11 shows a screen for a manager type user to sign up for the concierge system.

FIG. 12 shows a popup window for a user to access a search feature.

FIG. 13 shows a screen to create a business in the concierge system.

FIG. 14 shows a screen for a staff type (or role) user to sign up for the concierge system.

FIG. 15 shows a screen of a zip code entry feature of the concierge system.

FIG. 16 shows a screen of a chat feature of the concierge system.

FIG. 17 shows a screen of a chat bar sorting recent chats by roles.

FIG. 18 shows a screen of a contacts feature of the concierge system.

FIG. 19 shows a screen of an invitation feature of the concierge system.

### DETAILED DESCRIPTION OF THE INVENTION

FIG. 1 is a simplified block diagram of a distributed computer network 100 incorporating an embodiment of the present invention. Computer network 100 includes a number of client systems 113, 116, and 119, and a server system 122 coupled to a communication network 124 via a plurality of communication links 128. Communication network 124 provides a mechanism for allowing the various components of distributed network 100 to communicate and exchange information with each other.

Communication network 124 may itself be comprised of many interconnected computer systems and communication links. Communication links 128 may be hardwire links, optical links, satellite or other wireless communications links, wave propagation links, or any other mechanisms for communication of information. Communication links 128 may be DSL, Cable, Ethernet or other hardwire links, passive or active optical links, 3G, 3.5G, 4G and other mobility, satellite or other wireless communications links, wave propagation links, or any other mechanisms for communication of information.

Various communication protocols may be used to facilitate communication between the various systems shown in FIG. 1. These communication protocols may include VLAN, MPLS, TCP/IP, Tunneling, HTTP protocols, wireless application protocol (WAP), vendor-specific protocols, customized protocols, and others. While in one embodiment, communication network 124 is the Internet, in other embodiments, communication network 124 may be any suitable communication network including a local area network (LAN), a wide area network (WAN), a wireless network, an intranet, a private network, a public network, a switched network, and combinations of these, and the like.

Distributed computer network 100 in FIG. 1 is merely illustrative of an embodiment incorporating the present invention and does not limit the scope of the invention as recited in the claims. One of ordinary skill in the art would recognize other variations, modifications, and alternatives. For example, more than one server system 122 may be connected to communication network 124. As another example, a number of client systems 113, 116, and 119 may be coupled to communication network 124 via an access provider (not shown) or via some other server system.

Client systems 113, 116, and 119 typically request information from a server system which provides the information. For this reason, server systems typically have more computing and storage capacity than client systems. However, a particular computer system may act as both as a client or a server depending on whether the computer system is requesting or providing information. Additionally, although aspects of the invention have been described using a client-server environment, it should be apparent that the invention may also be embodied in a stand-alone computer system.

Server 122 is responsible for receiving information requests from client systems 113, 116, and 119, performing processing required to satisfy the requests, and for forwarding the results corresponding to the requests back to the requesting client system. The processing required to satisfy the request may be performed by server system 122 or may alternatively be delegated to other servers connected to communication network 124.

Client systems 113, 116, and 119 enable users to access and query information stored by server system 122. In a specific embodiment, the client systems can run as a standalone application such as a desktop application or mobile smartphone or tablet application. In another embodiment, a “Web browser” application executing on a client system enables users to select, access, retrieve, or query information stored by server system 122. Examples of Web browsers include the Internet Explorer browser program provided by Microsoft Corporation, Firefox browser provided by Mozilla, Chrome browser provided by Google, Safari browser provided by Apple, and others.

In a client-server environment, some resources (e.g., files, music, video, or data) are stored at the client while others are stored or delivered from elsewhere in the network, such as a server, and accessible via the network (e.g., the Internet). Therefore, the user's data can be stored in the network or “cloud.” For example, the user can work on documents on a client device that are stored remotely on the cloud (e.g., server). Data on the client device can be synchronized with the cloud.

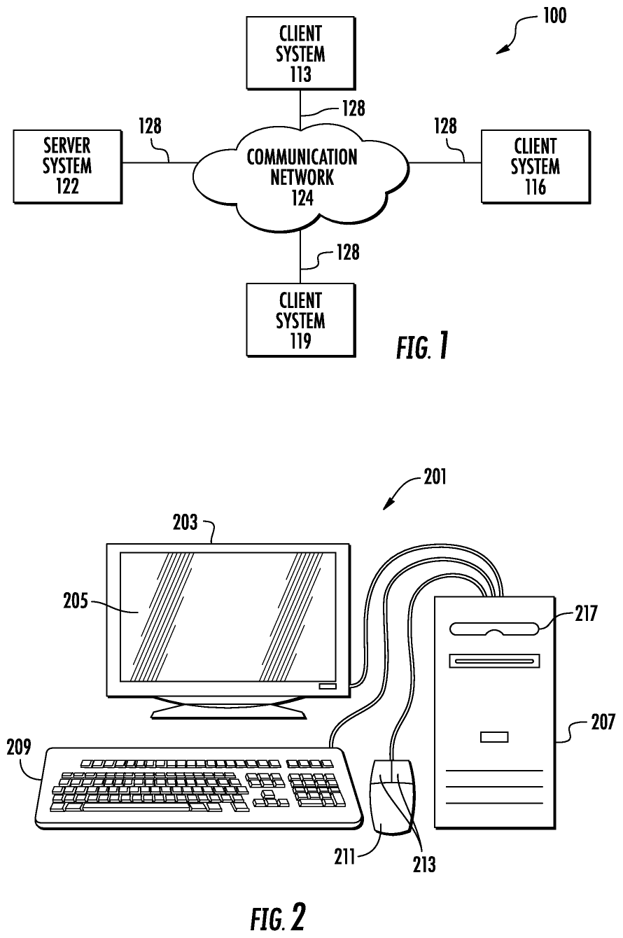

FIG. 2 shows an exemplary client or server system of the present invention. In an embodiment, a user interfaces with the system through a computer workstation system, such as shown in FIG. 2. FIG. 2 shows a computer system 201 that includes a monitor 203, screen 205, enclosure 207 (may also be referred to as a system unit, cabinet, or case), keyboard or other human input device 209, and mouse or other pointing device 211. Mouse 211 may have one or more buttons such as mouse buttons 213.

It should be understood that the present invention is not limited any computing device in a specific form factor (e.g., desktop computer form factor), but can include all types of computing devices in various form factors. A user can interface with any computing device, including smartphones, personal computers, laptops, electronic tablet devices, global positioning system (GPS) receivers, portable media players, personal digital assistants (PDAs), other network access devices, and other processing devices capable of receiving or transmitting data.

For example, in a specific implementation, the client device can be a smartphone or tablet device, such as the Apple iPhone (e.g., Apple iPhone 6), Apple iPad (e.g., Apple iPad, Apple iPad Pro, or Apple iPad mini), Apple iPod (e.g., Apple iPod Touch), Samsung Galaxy product (e.g., Galaxy S series product or Galaxy Note series product), Google Nexus and Pixel devices (e.g., Google Nexus 6, Google Nexus 7, or Google Nexus 9), and Microsoft devices (e.g., Microsoft Surface tablet). Typically, a smartphone includes a telephony portion (and associated radios) and a computer portion, which are accessible via a touch screen display.

There is nonvolatile memory to store data of the telephone portion (e.g., contacts and phone numbers) and the computer portion (e.g., application programs including a browser, pictures, games, videos, and music). The smartphone typically includes a camera (e.g., front facing camera or rear camera, or both) for taking pictures and video. For example, a smartphone or tablet can be used to take live video that can be streamed to one or more other devices.

Enclosure 207 houses familiar computer components, some of which are not shown, such as a processor, memory, mass storage devices 217, and the like. Mass storage devices 217 may include mass disk drives, floppy disks, magnetic disks, optical disks, magneto-optical disks, fixed disks, hard disks, CD-ROMs, recordable CDs, DVDs, recordable DVDs (e.g., DVD-R, DVD+R, DVD-RW, DVD+RW, HD-DVD, or Blu-ray Disc), flash and other nonvolatile solid-state storage (e.g., USB flash drive or solid state drive (SSD)), battery-backed-up volatile memory, tape storage, reader, and other similar media, and combinations of these.

A computer-implemented or computer-executable version or computer program product of the invention may be embodied using, stored on, or associated with computer-readable medium. A computer-readable medium may include any medium that participates in providing instructions to one or more processors for execution. Such a medium may take many forms including, but not limited to, nonvolatile, volatile, and transmission media. Nonvolatile media includes, for example, flash memory, or optical or magnetic disks. Volatile media includes static or dynamic memory, such as cache memory or RAM. Transmission media includes coaxial cables, copper wire, fiber optic lines, and wires arranged in a bus. Transmission media can also take the form of electromagnetic, radio frequency, acoustic, or light waves, such as those generated during radio wave and infrared data communications.

For example, a binary, machine-executable version, of the software of the present invention may be stored or reside in RAM or cache memory, or on mass storage device 217. The source code of the software of the present invention may also be stored or reside on mass storage device 217 (e.g., hard disk, magnetic disk, tape, or CD-ROM). As a further example, code of the invention may be transmitted via wires, radio waves, or through a network such as the Internet.

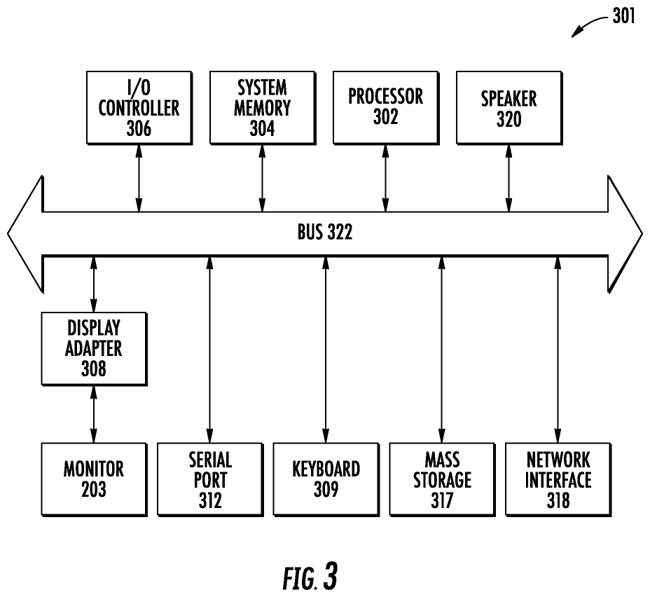

FIG. 3 shows a system block diagram of computer system 201 used to execute the software of the present invention. As in FIG. 2, computer system 201 includes monitor 203, keyboard 209, and mass storage devices 217. Computer system 201 further includes subsystems such as central processor 302, system memory 304, input/output (I/O) controller 306, display adapter 308, serial or universal serial bus (USB) port 312, network interface 318, and speaker 320. The invention may also be used with computer systems with additional or fewer subsystems. For example, a computer system could include more than one processor 302 (i.e., a multiprocessor system) or a system may include a cache memory.

Arrows such as 322 represent the system bus architecture of computer system 201. However, these arrows are illustrative of any interconnection scheme serving to link the subsystems. For example, speaker 320 could be connected to the other subsystems through a port or have an internal direct connection to central processor 302. The processor may include multiple processors or a multicore processor, which may permit parallel processing of information. Computer system 201 shown in FIG. 3 is but an example of a computer system suitable for use with the present invention. Other configurations of subsystems suitable for use with the present invention will be readily apparent to one of ordinary skill in the art.

Computer software products may be written in any of various suitable programming languages, such as C, C++, C#, Pascal, Fortran, Perl, Matlab (from MathWorks, www.mathworks.com), SAS, SPSS, JavaScript, AJAX, Java, Python, Erlang, and Ruby on Rails. The computer software product may be an independent application with data input and data display modules. Alternatively, the computer software products may be classes that may be instantiated as distributed objects. The computer software products may also be component software such as Java Beans (from Oracle Corporation) or Enterprise Java Beans (EJB from Oracle Corporation).

An operating system for the system may be one of the Microsoft Windows® family of systems (e.g., Windows 95, 98, Me, Windows NT, Windows 2000, Windows XP, Windows XP x64 Edition, Windows Vista, Windows 7, Windows 8, Windows 10, Windows CE, Windows Mobile, Windows RT), Symbian OS, Tizen, Linux, HP-UX, UNIX, Sun OS, Solaris, Mac OS X, Apple iOS, Android, Alpha OS, AIX, IRIX32, or IRIX64. Other operating systems may be used. Microsoft Windows is a trademark of Microsoft Corporation.

Any trademarks or service marks used in this patent are property of their respective owner. Any company, product, or service names in this patent are for identification purposes only. Use of these names, logos, and brands does not imply endorsement.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, 802.11ac, and 802.11ad, just to name a few examples), near field communication (NFC), radio-frequency identification (RFID), mobile or cellular wireless (e.g., 2G, 3G, 4G, 3GPP LTE, WiMAX, LTE, LTE Advanced, Flash-OFDM, HIPERMAN, iBurst, EDGE Evolution, UMTS, UMTS-TDD, 1×RDD, and EV-DO). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download Web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

In other implementations, the user accesses the system through either or both of native and nonnative applications. Native applications are locally installed on the particular computing system and are specific to the operating system or one or more hardware devices of that computing system, or a combination of these. These applications (which are sometimes also referred to as “apps”) can be updated (e.g., periodically) via a direct internet upgrade patching mechanism or through an applications store (e.g., Apple iTunes and App store, Google Play store, Windows Phone store, and Blackberry App World store).

The system can run in platform-independent, nonnative applications. For example, client can access the system through a Web application from one or more servers using a network connection with the server or servers and load the Web application in a Web browser. For example, a Web application can be downloaded from an application server over the Internet by a Web browser. Nonnative applications can also be obtained from other sources, such as a disk.

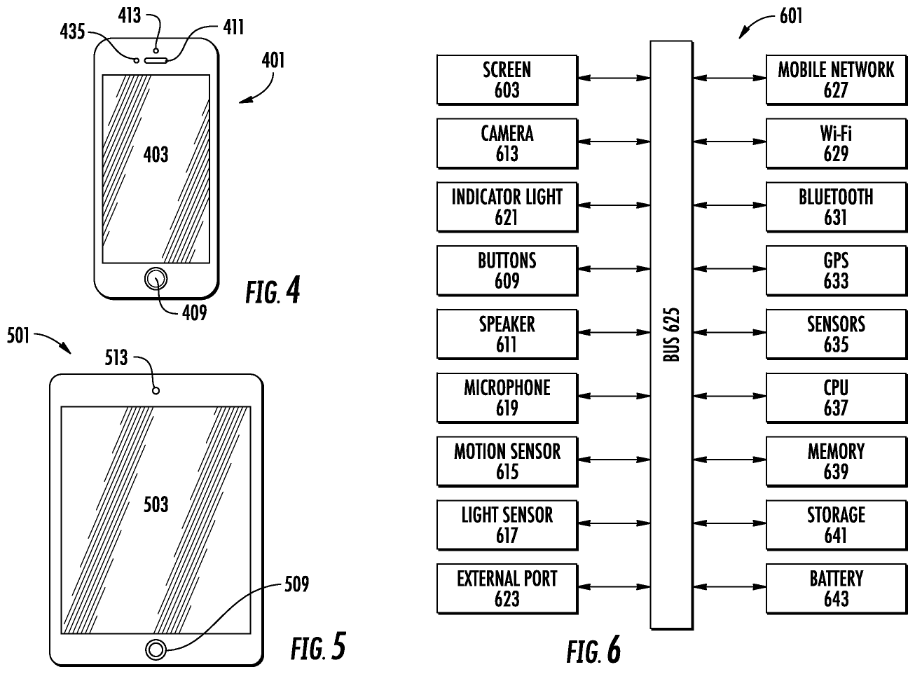

FIGS. 4-5 show examples of mobile devices, which can be mobile clients. Mobile devices are specific implementations of a computer, such as described above. FIG. 4 shows a smartphone device 401, and FIG. 5 shows a tablet device 501. Some examples of smartphones include the Apple iPhone, Samsung Galaxy, and Google Nexus family of devices. Some examples of tablet devices include the Apple iPad, Apple iPad Pro, Samsung Galaxy Tab, and Google Nexus family of devices.

Smartphone 401 has an enclosure that includes a screen 403, button 409, speaker 411, camera 413, and proximity sensor 435. The screen can be a touch screen that detects and accepts input from finger touch or a stylus. The technology of the touch screen can be a resistive, capacitive, infrared grid, optical imaging, or pressure-sensitive, dispersive signal, acoustic pulse recognition, or others. The touch screen is screen and a user input device interface that acts as a mouse and keyboard of a computer.

Button 409 is sometimes referred to as a home button and is used to exit a program and return the user to the home screen. The phone may also include other buttons (not shown) such as volume buttons and on-off button on a side. The proximity detector can detect a user's face is close to the phone, and can disable the phone screen and its touch sensor, so that there will be no false inputs from the user's face being next to screen when talking.

Tablet 501 is similar to a smartphone. Tablet 501 has an enclosure that includes a screen 503, button 509, and camera 513. Typically the screen (e.g., touch screen) of a tablet is larger than a smartphone, usually 7, 8, 9, 1, 3, 4, or more inches (measured diagonally).

FIG. 6 shows a system block diagram of mobile device 601 used to execute the software of the present invention. This block diagram is representative of the components of smartphone or tablet device. The mobile device system includes a screen 603 (e.g., touch screen), buttons 609, speaker 611, camera 613, motion sensor 615, light sensor 617, microphone 619, indicator light 621, and external port 623 (e.g., USB port or Apple Lightning port). These components can communicate with each other via a bus 625.

The system includes wireless components such as a mobile network connection 627 (e.g., mobile telephone or mobile data), Wi-Fi 629, Bluetooth 631, GPS 633 (e.g., detect GPS positioning), other sensors 635 such as a proximity sensor, CPU 637, RAM memory 639, storage 641 (e.g., nonvolatile memory), and battery 643 (lithium ion or lithium polymer cell). The battery supplies power to the electronic components and is rechargeable, which allows the system to be mobile.

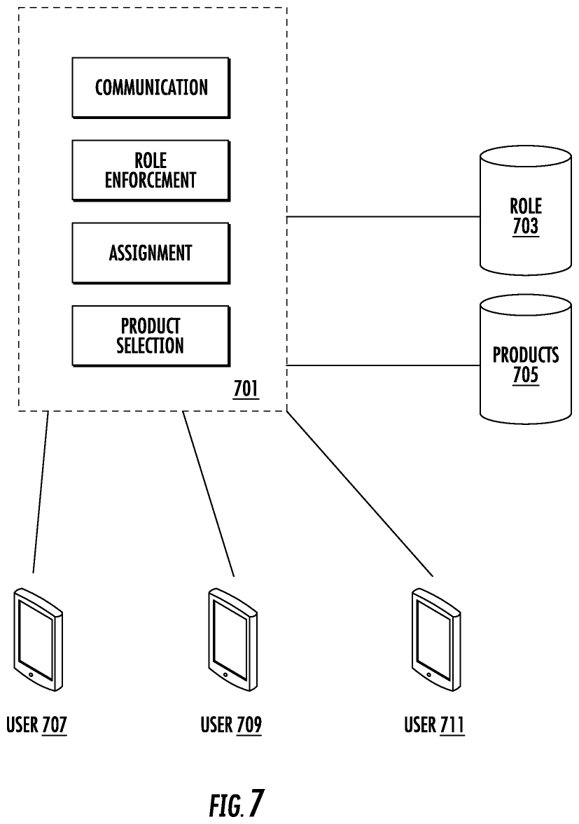

FIG. 7 shows a system diagram, in an embodiment of the concierge system. A concierge system server 701 provides various features of the concierge system. A communication feature allows users of the concierge system to communicate with each other, such as to make requests in the concierge system or discuss how to accomplish requested tasks. A role enforcement feature may query a role database 703 to determine a role for any particular user. Depending on a user's role, they may be limited to certain features of the concierge system. For example, the concierge system may include an assignment feature that may or may not be available to certain users of the concierge system depending on their role. A product selection feature creates queries executed on a products database 705. For example, in an embodiment of the concierge system where the concierge system is used to provide meals, the products database 705 may include recipes and lists of ingredients for dishes. For example, users 707, 709, and 711 may access the concierge system on mobile devices or other computing devices. When a user requests a meal, the concierge system may select dishes and lists of ingredients to create the dishes.

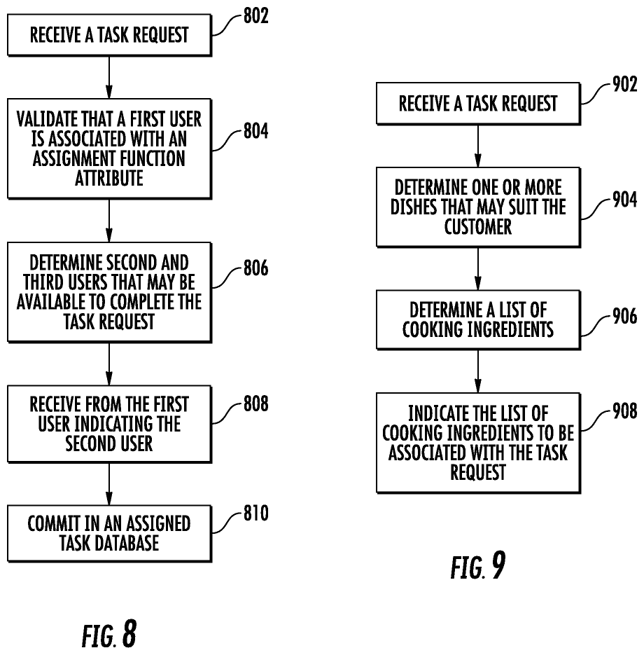

FIG. 8 shows a flow of assigning tasks in the concierge system, in an implementation. This application includes flows including a series of steps, however these flows are for illustrative purposes only. Various embodiments of the concierge system may include greater or fewer steps than shown by flows included.

In a step 802, the concierge system includes receiving a task request to be performed at a specified location. For example, this may be a task request for helping a customer prepare dinner.

In a step 804, the concierge system includes validating that a first user is associated with an assignment function attribute. The concierge system verifies whether the first user is of the proper functional role. For example, a functional role may determine whether a user is a manager and thus has an assignment function attribute to allow the user to assign tasks in the concierge system to other users.

In a step 806, the concierge system includes determining second and third users in a second functional role that may be available to complete the task request based at least in part on their relevance to the specified location. This determination may be based in part on the first user being associated with the assignment function attribute, the task request, and the specified location. The specified location may be a location where the task is to be performed. For example, for a delivery service, this may be a home address of a customer or other place where the customer may want their delivery to occur. The concierge system may determine that the second and third users are more relevant to the specified location than other users of the concierge system. This may mean that, based on the geolocation information of the second and third users, they are closer than other users and thus more suitable for timely service of the request. Further, the relevance may be determined based on familiarity the second or third users to the specified location, that allows them to service the request. Using this information, the first user receives information that the second or third users may be available to complete the task.

In a step 808, the concierge system includes receiving from the first user an indication that the second user but not the third user has been selected to complete the task request. The first user, with the assignment function attribute, may select the first user to complete the task. The first user may not need to explicitly unselect the third user from the request, but if the task only requires one user, the concierge system will not include the third user in the request.

In a step 810, the concierge system includes committing in an assigned task database information on the task request and the second user as being selected to complete the task request. For example, the assigned task database may be used to track which users have been assigned requests to determine their availability for other requests or for tracking how many requests they have been assigned to in the concierge system. The concierge system may transmit to the second user that they have been selected to complete the task request and the specified location.

FIG. 9 shows a flow of fulfilling a task request in the concierge system, in an implementation. In a step 902, the concierge system includes receiving a task request. The task request may be to select items for cooking.

In a step 904, the concierge system includes determining, based on a user profile of a customer user making the task request, one or more dishes that may suit the customer. This may be based on the customer's preferences or requirements, availability of raw ingredients to create dishes, menu set of the concierge system, other factors affecting available dishes, or any combination of these.

In a step 906, the concierge system includes determining a list of cooking ingredients that the customer may use to create the one or more dishes. In a step 908, the concierge system includes indicating, in response to the task request, the list of cooking ingredients to be associated with the task request.

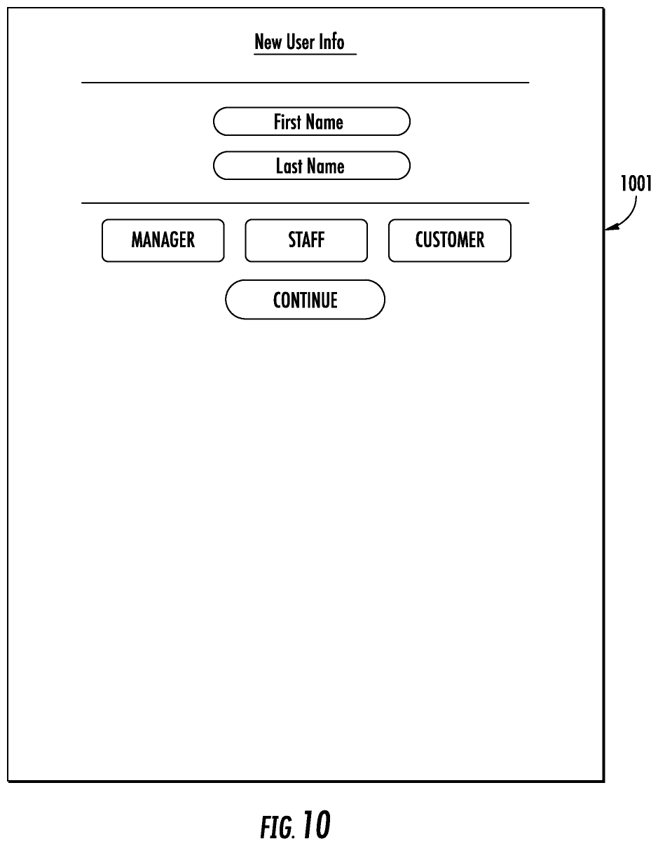

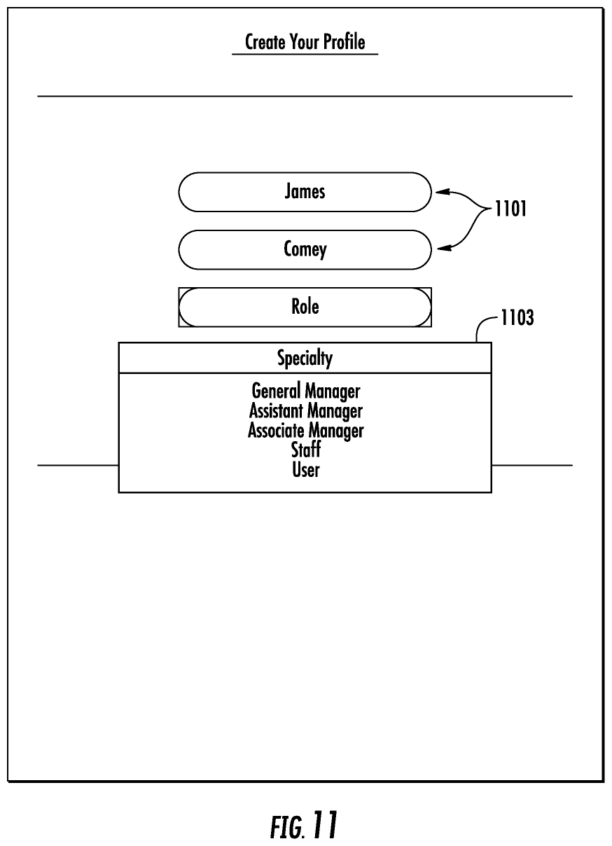

FIGS. 10-19 show screens of the concierge system, in an implementation. The concierge system may be used to facilitate a delivery service by providing a seamless method for customers to order goods or services, such as groceries, and have their orders fulfilled. For example, the concierge system may include features allowing customers to have their orders purchased and delivered to their doorstep. The concierge system may also include features for different roles of users to manage, supervise, or oversee the entire interaction.

In an implementation, the concierge system acts like a personal assistant for customers. For example, the concierge system may provide a curated experience that purchases and delivers ingredients to customers so that they may cook their own meals. A menu of items available or cash for payment is not required. The concierge system may determine, based on information provided by customers, what kind of meals are suitable for a particular customer and provide ingredients to the customer to cook suitable meals. A meal may include one or more dishes. For example, a single meal may include an appetizer, entrée, dessert, or any combination of these.

A customer may have certain dietary requirements or preferences. For example, the customer may indicate when they create their account or later that they are omnivorous, vegetarian, pescatarian, vegan, have a particular food allergy (e.g., nuts, shellfish, fruits), enjoys particular flavors (e.g., spicy, salty, sweet), or dislikes certain ingredients. Further, the customer may have indicated that they enjoyed or did not enjoy certain meals suggested by the concierge system. For example, the concierge system may solicit feedback for meals that were provided to the customer (e.g., whether they liked or disliked the meal, what parts of the meal they liked or disliked). The concierge system may select meals based on this information.

The concierge system may support various roles for different users of the concierge system. For example, there may be roles for General Manager, Assistant Manager, and Associate Manager. Roles are associated with user accounts and each respective role may grant or limit access to features of the concierge system in accordance with their particular role. An Owner or Manager user is allowed access to admin or controller features. Different types of managers (e.g., assistant manager, general manager, associate manager) may be allowed access to one or more manager features. A Staff user is allowed access to different staff features, such as driver, shopper, or accounting features. A customer user may represent different types of clients, such as a single person, a couple, or a family.

The concierge system may support various levels of encryption. In an implementation, the concierge system uses end-to-end encryption for messages. When using end-to-end encryption, messages sent between users of the concierge system are encrypted so that only users that are the intended recipient or sender of the message may decrypt the message.

FIG. 10 shows a screen for a user to sign up for the concierge system. The user may be associated with a customer, manager, or staff types by selecting the appropriate button 1001.

FIG. 11 shows a screen for a manager type user to sign up for the concierge system. The user provides their name in spaces 1101 and a drop-down menu 1103 is provided to select a role to be associated with the user. A “Role” is selected in the concierge system. The drop-down menu may include the following entries: [Role], [General Manager], [Assistant Manager], [Associate Manager].

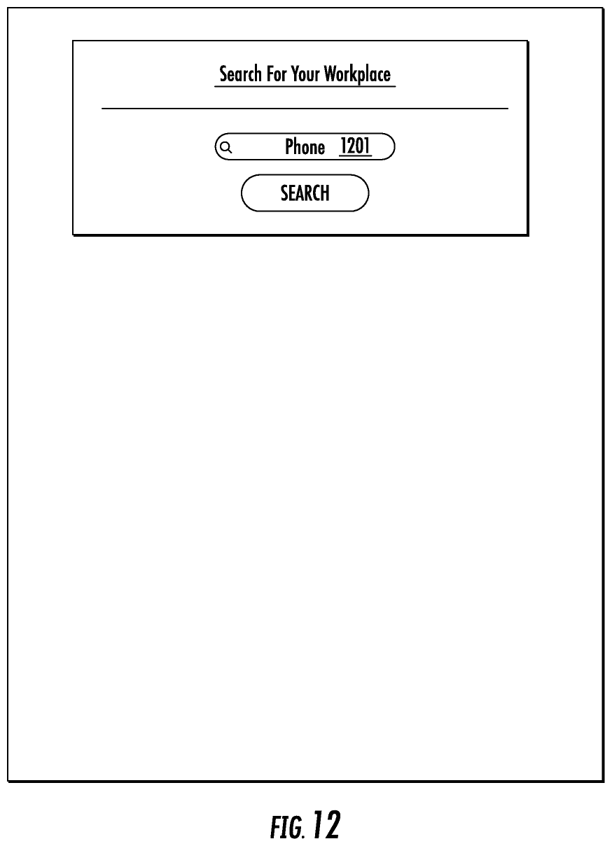

FIG. 12 shows a popup window for a user to access a search feature to find their business (or workplace). This may occur after email confirmation of the user's email account has been verified and allows the user to add their business information. The search may support business lookup using a phone number in space 1201, but other methods of identifying a business (e.g., name, employer identification number, address, email) may also be supported.

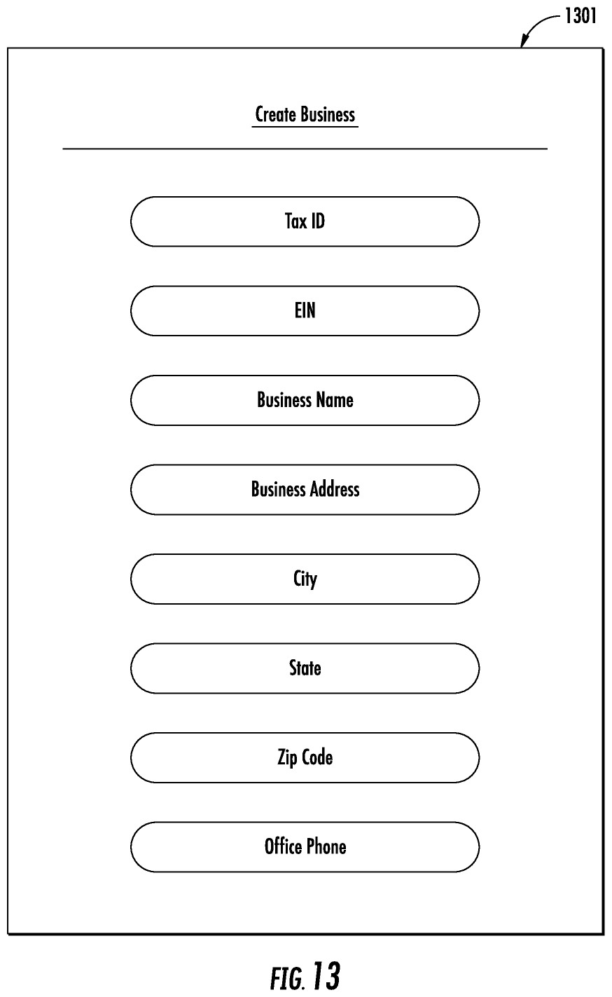

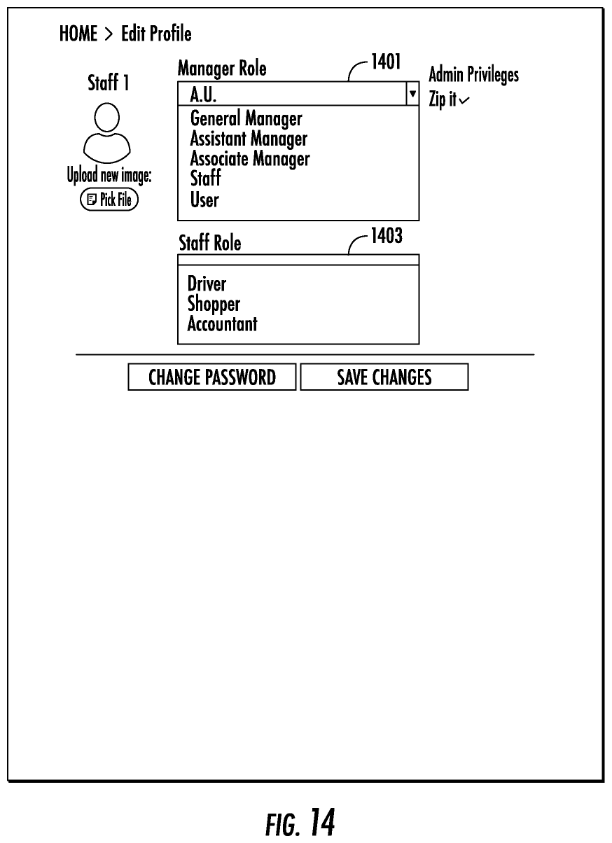

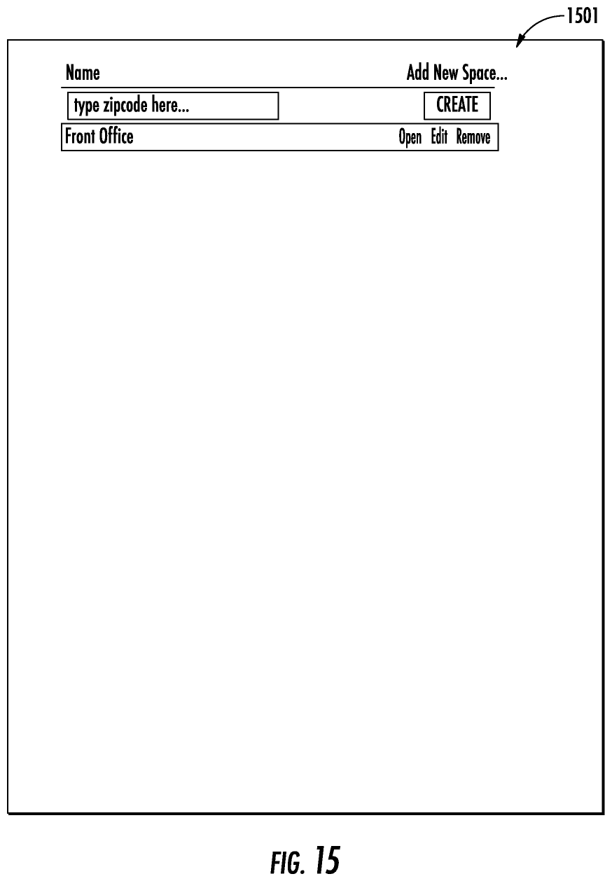

The concierge system may support businesses that are not found using the search feature. FIG. 13 shows a screen 1301 to create a business in the concierge system. In an implementation, the concierge system may include a tax identifier or employer identification field. This may be used to assist in tax purposes.

FIG. 14 shows a screen for a staff type (or role) user to sign up for the concierge system. The concierge system provides different roles a staff type user may have and selected using drop-down menu 1401. For example, this may include Driver, Shopper, and Accountant roles. Further, the concierge system may provide different roles for manager type users and selected using drop-down menu 1403. Some examples of roles include: General Manager, Assistant Manager, and Associate Manager.

In an implementation, the concierge system includes a chat feature. The chat feature may support different spaces, such as front office, back office, and a general default channel. The chat feature may also include chats by zip code. FIG. 15 shows a screen 1501 of a zip code entry feature of the concierge system. This allows users to identify particular concerns for other users of the concierge system, sorted by a particular area (e.g., zip code) for easy access. This allows the system to identify and use people greater knowledge about an area, to perform tasks in the area. For example, if a delivery person is making deliveries to a particular zip code, they may want to access information particular to the neighborhood (e.g., whether and when there may be traffic in the area, where to drop off packages), coordinate with others (e.g., discuss recent happenings with others, consolidate deliveries between multiple deliveries), or other reasons. When typing in a space, the concierge system may suggest a zip code as the input.

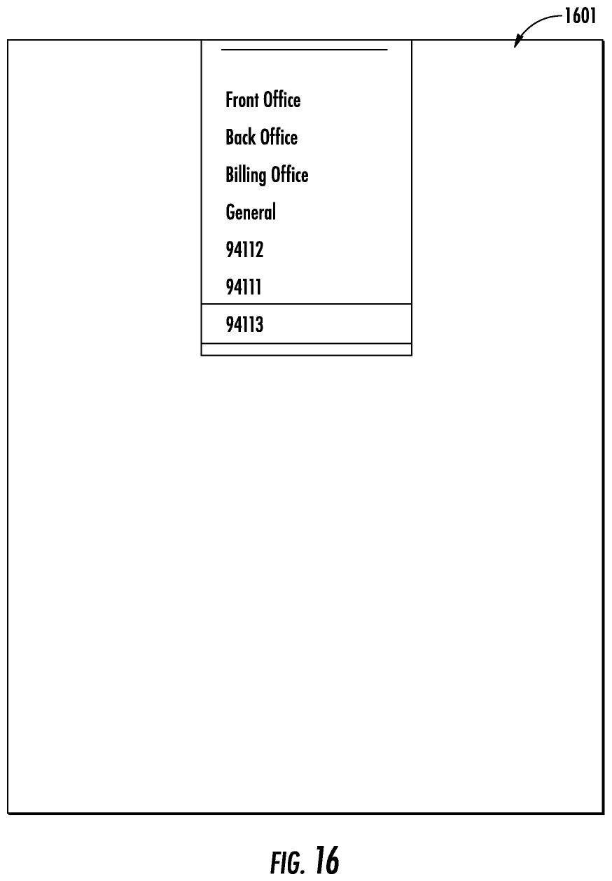

FIG. 16 shows a screen 1601 of a chat feature of the concierge system. Chats may be sorted by the zip code spaces as shown on the left by ascending or descending order. For example, the zip codes shown in the figure include 94111, 94112, and 94113 sorted in numerical order.

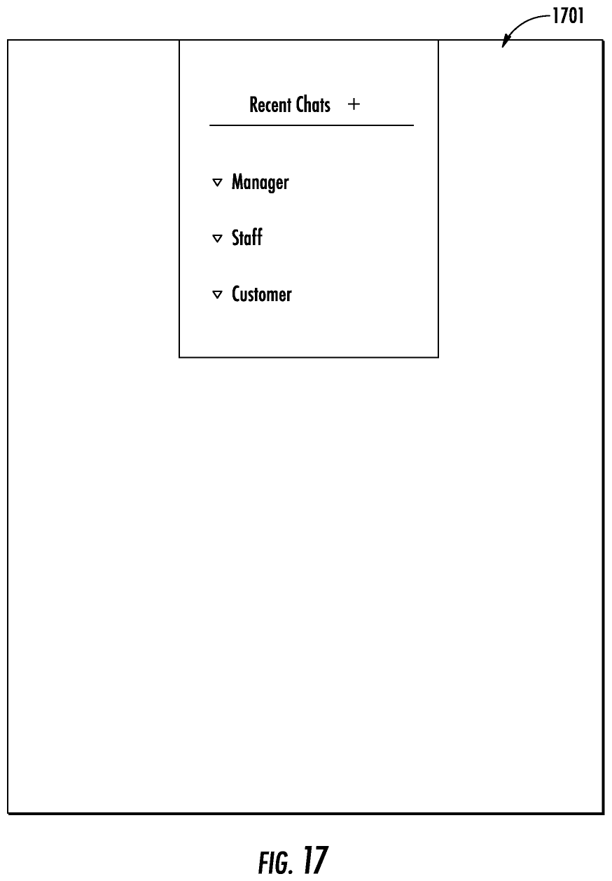

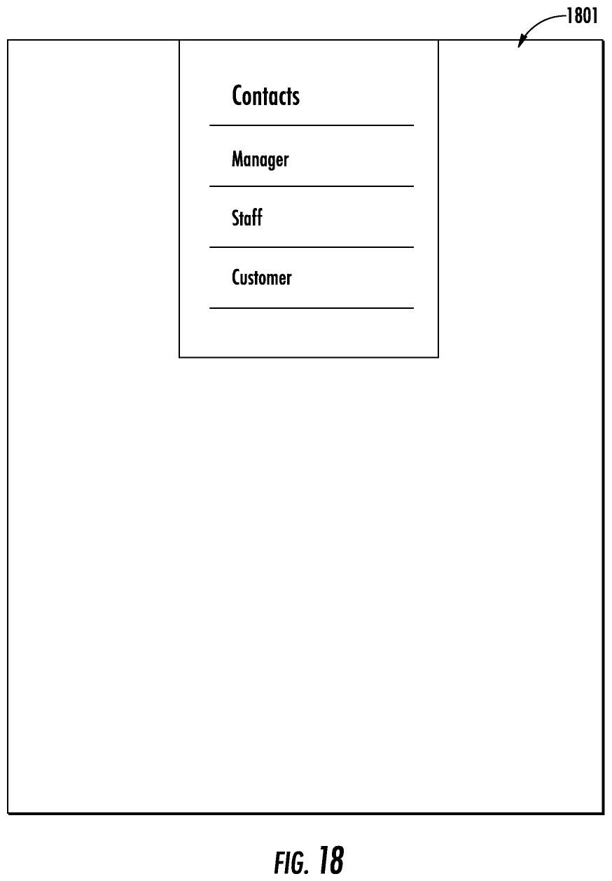

The chat feature may sort recent chats a user has with others by roles. FIG. 17 shows a screen 1701 of a chat bar sorting recent chats by roles. The concierge system includes Managers, Staff, and Customers roles. FIG. 18 shows a screen 1801 of a contacts feature of the concierge system. The concierge system includes Managers, Staff, and Customers roles.

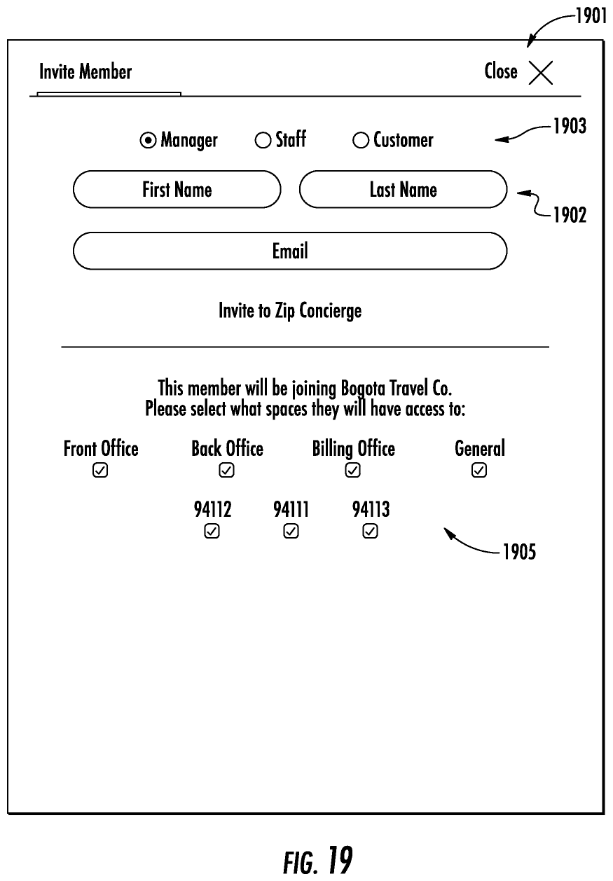

FIG. 19 shows a screen 1901 of an invitation feature of the concierge system. The invitation feature allows an existing user to invite additional users to the concierge system. The inviting user must specify certain details to be associated with the invited user, such as their name 1902, type (e.g., manager, staff, customer) 1903, email, and which spaces the invited user should have access to 1905.

The concierge system may also include a mobile application. The invite & signup process is similar to the desktop process as shown in FIGS. 10-19.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A method comprising:
receiving a task request to be performed at a specified location;
retrieving by a first user in a first functional role information on the task request;
validating that the first user is associated with an assignment function attribute, wherein the assignment function attribute designates an associated user as allowing assignments of users to tasks;
determining, based on the first user being associated with the assignment function attribute, the task request, and the specified location, second and third users in a second functional role that may be available to complete the task request based at least in part on their relevance to the specified location;
transmitting to the first user information identifying that the second and third users may be available to complete the task request;
receiving from the first user an indication that the second user but not the third user has been selected to complete the task request;
committing in an assigned task database information on the task request and the second user as being selected to complete the task request; and
transmitting to the second user that they have been selected to complete the task request and the specified location.

2. The method of claim 1 comprising:
determining, based on a user profile of a customer user making the task request, one or more dishes that may suit the customer;
determining a list of cooking ingredients that the customer may use to create the one or more dishes; and
indicating, in response to the task request, the list of cooking ingredients to be associated with the task request.

3. The method of claim 2 wherein the user profile indicates a dietary preference.

4. The method of claim 2 wherein the user profile indicates an allergy.

5. The method of claim 1 wherein the first and second functional roles are different functional roles.

6. The method of claim 1 wherein the first functional role corresponds to a manager.

7. The method of claim 6 wherein the second functional role corresponds to a staff member.

8. The method of claim 1 wherein the task request is retrieved by the first user based on a push command transmitted to the first user's device.

9. The method of claim 1 wherein the specified location is included by a customer user when the task request is created.

10. The method of claim 9 wherein the specified location comprises the customer user's home.

11. The method of claim 1 wherein the specified location comprises a location specified by a geolocation technique of the customer user's device.
